(19) United States
(12) Patent Application Publication
(10) Pub. No.: US 2026/0316474 A1
(43) Pub. Date: Oct. 15, 2026

(54) METHOD OF DIGITALLY PRINTING MULTIPLE LAYERS ON A WOOD-BASED SUBSTRATE FOR EXTERIOR APPLICATION

(71) Applicant: LOUISIANA-PACIFIC CORPORATION, NASHVILLE, TN (US)

(72) Inventors: MATTHEW E. VRAZEL, ST. PETERS, MO (US); BRIAN ST. GERMAIN, MT. JULIET, TN (US)

(21) Appl. No.: 19/644,956

(22) Filed: Apr. 10, 2026

Related U.S. Application Data
(60) Provisional application No. 63/786,841, filed on Apr. 10, 2025.
(60) Provisional application No. 64/030,077, filed on Apr. 5, 2026.

(51) Int. Cl. B41M 3/00; B41M 5/00; B41M 7/00; C09D 11/40; C09D 15/00; G06T 7/00; G06T 7/40

(52) U.S. Cl. CPC B41M 3/008; B41M 5/0017; B41M 5/0076; B41M 5/0088; B41M 7/0045; B41M 7/0081; C09D 11/40; C09D 15/00; G06T 7/001; G06T 7/40; G06T 2207/30144

(57) ABSTRACT

A system and related methods for high-resolution digital printing on wood-based substrates for exterior applications or outdoor use. Textured wood-based substrates include, but are not limited to, plywood, wood planks, oriented-strand board (OSB), laminated strand lumber (LSL), laminated veneer lumber (LVL), paper board, and various forms of engineered wood. A manufactured or engineered wood product with an engineered orientation is used as the base substrate to minimize deformation. Multiple layers of UV-resistant ink may be applied and cured sequentially. Printing may be used to enhance or modify an embossed texture pattern on the substrate.

This application claims priority to and benefit of U.S. Provisional Applications No. Application No. 63/786,841, filed Apr. 10, 2025; and No. 64/030,077, filed Apr. 5, 2026, all of which are incorporated hereby by specific reference in their entireties for all purposes.

### FIELD OF INVENTION

This invention relates to a system and related methods for digitally printing multiple layers on a wood-based substrate, including but not limited to engineered wood, for exterior application or outdoor use.

### BACKGROUND OF INVENTION

Prior art exterior wood products have required repeated and regular refinishing to maintain their aesthetic quality. Naturally-durable wood products such as cedar and redwood have been used for the exterior cladding of homes for hundreds of years. Over time natural deformation of the wood, driven by shrinking and swelling from free moisture, tended to compromise finishes, and thus this type of cladding requires repeated refinishing to maintain desirable aesthetics. Engineered wood products such as plywood experience similar issues with swelling and shrinking, though perhaps at different rates than natural wood. Wood-based products will continue to deform, even at the fiber level, unless the surface can be stabilized.

Typical decay treatments would slow down or stop decay, but not change the natural deformation of the surface. These treatments serve more to stop or slow the growth of fungi rather change the water absorption characteristics of the wood. Water impervious treatments such as paraffin waxes and film forming finishes would serve to slow the surface decay affects and extend service life, though themselves would not greatly extend the aesthetic performance and generally required great effort to refinish in the field.

A further complication with wood products, even engineered wood products is that the wood fiber is typically able to take on only certain types of finishes. The high absorbency of the wood fiber required a finish with high content of water or volatile organics and a process to drive off the liquid carrier.

Other methods have been employed to create a wood fiber-based substrate which was more resistant to shrinking and swelling. Chemical methods such as phenol formaldehyde impregnation typically required significant amounts of resin to be forced into the dried wood product in an industrial setting, then a second drying process to drive off the water carrier. While successful in reducing deformation of wood products treatments are often extremely costly and have downsides with manufacturing and emissions control.

With the expectation of deformation, wood finishes are largely limited to non-film forming colorants and dyes or film forming highly flexible finishes. A stain usually highlights the existing wood grain, or a paint provides a heavy film that tend to be a very simple, mono-tone finish. The colorant and dyes tend to color the wood fiber and are very susceptible to UV fade which require frequent maintenance. Film forming finishes tend to break down due to deformation of the wood which breaks the film barrier and again requires maintenance.

A second problem for the application of film forming and decorative finishes is the adhesion to the wood fiber itself. Adhesion directly to the fiber is for the most part mechanical in nature. Since the wood will be deforming at the fiber level, mechanical bonds will begin to breakdown as the fibers change shape relative to each other. Over time this will loosen even the strongest adhesive or finish and, in some cases, the remaining adhesion will separate the fiber from the main body of the wood resulting in tear-out.

Surface deformation on wood products as discussed above continues to cause significant challenges to the long-term durability of high value finishes, such as ink jet printing, in exterior applications. Materials such as plastic (e.g., HDPE for decking, PVC for fencing, and the like) and aluminum siding have been used extensively with decorative finishes such as pre-printed films and direct-to-substrate printing. However, these techniques used on metal or plastic substrates will not work on wood products. Accordingly, there continues to be a need for a system and method for high-resolution printing on wood-based substrates for exterior application or outdoor use.

### SUMMARY OF INVENTION

In various exemplary embodiments, the present invention comprises a system and related methods for high-resolution digital printing on wood-based substrates for exterior application or outdoor use. Textured wood-based substrates include, but are not limited to, plywood, wood planks, oriented-strand board (OSB), laminated strand lumber (LSL), laminated veneer lumber (LVL), paper board, and various forms of engineered wood. The present invention allows the high-quality duplication of the aesthetic and textural features of a particular type or style of board or panel on the substrate, or printing of an image or images on the substrate.

The present invention addresses the above problems with a manufactured or engineered wood product that is used as the base substrate. The engineered wood product comprises wood fibers with an engineered orientation (along with resin as a binder), which minimizes the deformation of the wood in certain orientations. A resin-impregnated paper overlay is then applied (typically during the manufacturing process or during finishing) over the engineered wood substrate. In one embodiment, the paper overlay is a medium density resin-impregnated paper overlay. The combination of the oriented substrate and the paper overlay provides an ideal surface for application of printed images subject to exposure outdoors. In a further embodiment, the paper overlay may be impregnated with an additional primer layer.

In several additional embodiments, the ink used for printing is formulated for outdoor use. The ink may be a plurality of UV-resistant inks applied to the surface with a variety of printing technologies (e.g., transfer, rotogravure and/or ink jet systems). A clear or transparent protective layer also may be applied over the printed ink on the surface. This protective layer may be in solid form (e.g., film overlay) or liquid form (e.g., liquid coating). In several embodiments, the protective layer may be applied during and/or after the printing process.

In a preferred embodiment, go through a multi-step, multi-color digital printing process. This may occur in the same facility as the processes described herein, or may occur in a separate building or facility. The boards and/or panels pass through or under an industrial digital printer with multiple print heads and curing lights that performs the following steps in a continuing sequence as the boards/panels pass through or underneath. An ink primer is applied to the upper surface of the board or panel (which typically comprises a primed overlay). The ink primer is cured, typically by a primer-curing UV light. A first ink color is applied by a first ink print head on the surface with cured ink primer. The first ink color is cured by a first UV light. This is repeated for subsequent colors. After the curing of the last color, an ink clear coat is applied, and cured. The entire board or panel may then be subject to a full cure.

In additional embodiments, the system scans the surface of the board or panel before printing to identify the presence and topography of any embossed cedar or other texture, and adjust the printing of the inks to match the embossed texture, as described above. Alternatively, the system may have a digital map of the entirety of the texture pattern (i.e., the entire texture pattern on a press platen), and then scanning portions (e.g., a portion of the ends) or all of the board or panel to first determine what portion of the texture digital map is present on the surface of the board or panel, and then make adjustments based on that determination.

In several embodiments, the present invention comprises the printing of ink to highlight or enhance the 3-dimensional cedar texture or other texture. This includes, but is not limited to, adding shading, highlights, shadows, wood knots, defects, or similar enhancements to emphasize or de-emphasize certain elements or portions of the board. The system may scan the surface of the board or panel before printing to identify the presence and topography of any embossed cedar texture or other texture, and adjust the printing of the inks to match the embossed texture, as described above.

### BRIEF DESCRIPTION OF THE DRAWINGS

FIG. 1 shows a diagram of a method in accordance with an exemplary embodiment of the present invention.

FIG. 2 shows a view of a multi-layered wood-substrate product for exterior use in accordance with an exemplary embodiment of the present invention.

FIG. 3 shows a cross-section view of a multi-layered wood-substrate product with digital printing for exterior use in accordance with another exemplary embodiment of the present invention.

FIGS. 4-8 show top views of pieces of siding with digital printing in accordance with exemplary embodiments of the present invention.

FIG. 9 shows a diagram of a method to apply multiple ink layers in sequence in accordance with another exemplary embodiment of the present invention.

FIG. 10 shows a diagram of a method to enhance embossing or contours on a multi-layered wood-substrate product with digital printing for exterior use.

### DETAILED DESCRIPTION OF EXEMPLARY EMBODIMENTS

In various exemplary embodiments, the present invention comprises a system and related methods for high-resolution digital printing of multiple layers on wood-based substrates for exterior application or outdoor use. Textured wood-based substrates include, but are not limited to, plywood, wood planks, oriented-strand board (OSB), laminated strand lumber (LSL), laminated veneer lumber (LVL), paper board, and various forms of engineered wood. The present invention allows the high-quality duplication of the aesthetic and textural features of a particular type or style of board or panel on the substrate, or printing of an image or images on the substrate. The engineered wood substrate and product can be of any type used in an exterior application, including, but not limited to, fencing, fence panels, fence pickets, fence posts or other components, decking, deck planks, deck beams, deck posts, deck beams or other components, siding or siding components, roofing or roofing components, exterior doors, outdoor posts or supports, and the like.

Printing images onto wood products has been limited to interior applications since wood will tend to shrink and swell (and warp) in exterior conditions (i.e., outdoors), thereby causing the image to distort and/or break. The movement is caused by the gain and loss of moisture, which causes the swelling and shrinking (respectively) of the wood fiber. This translates into gross swell as well as deformation of the wood product. While non-wood products have been used in exterior applications, wood or engineered wood is less expensive and provides a more authentic look and feel as compared to non-wood products.

The present invention addresses the above-described problems with a manufactured or engineered wood product that is used as the base substrate, with multiple printed layers and protective layers placed or printed thereon. A class of engineered-wood products are multilayer oriented wood strand particleboards, particularly those with a layer-to-layer oriented strand pattern, such as “OSB”. Oriented, multilayer wood strand boards are composed of several layers (e.g., bottoms strand layer 10b, core strand layer 10c, and top strand layer 10t) of thin wood strands, which are wood particles having a length which is several times greater than their width. These strands are formed by slicing larger wood pieces so that the fiber elements in the strands are substantially parallel to the strand length. The strands in each layer are positioned relative to each other with their length in substantial parallel orientation and extending in a direction approaching a line which is parallel to one edge of the layer. The layers are positioned relative to each other with the oriented strands of adjacent layers perpendicular, forming a layer-to-layer cross-oriented strand pattern. Oriented, multilayer wood strand boards of the above-described type, and examples of processes for pressing and production thereof, are described in detail in US. U.S. Pat. Nos. 3,164,511, 4,364,984, 5,425,976, 5,470,631, 5,525,394, 5,718,786, and 6,461,743, all of which are incorporated herein in their entireties by specific reference for all purposes.

Certain oriented board products can be made from flakes that are created from debarked round logs by placing the edge of a cutting knife parallel to a length of the log and the slicing thin flakes from the log. The cut flakes are subjected to forces that break the flakes into strands having a length parallel to the grain of the wood several times the width of the strand. The strands can be oriented on the board-forming machine with the strands predominantly oriented in a single (e.g., cross-machine) direction in one (e.g., core) layer and predominantly oriented in the generally perpendicular (machine) direction in adjacent layers.

A system for digital printing on a wood-based substrate for exterior application is disclosed in U.S. patent application Ser. No. 16/991,954, filed Aug. 12, 2020, published as US 2021-0046741 A1 (Feb. 18, 2021) which is incorporated herein by specific reference for all purposes. The present invention, as described herein, discloses additional systems and methods, as described in more detail below.

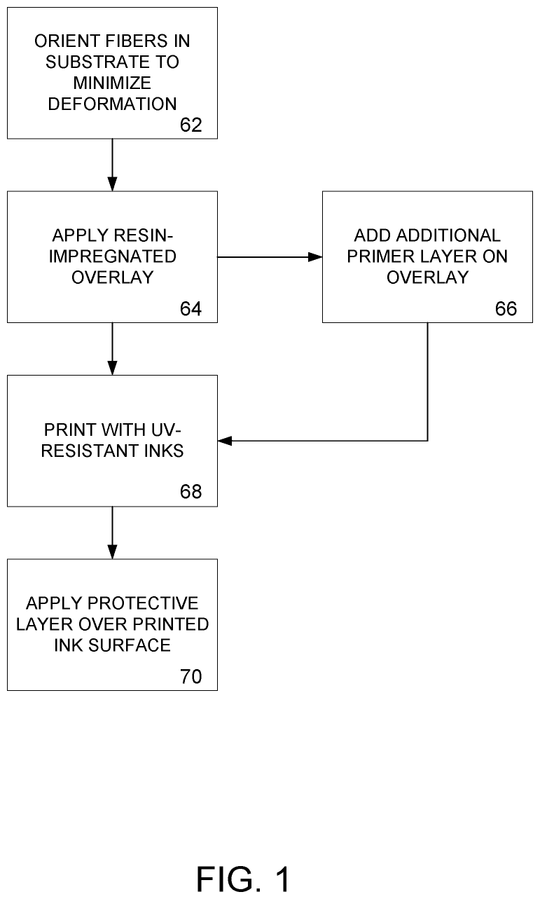

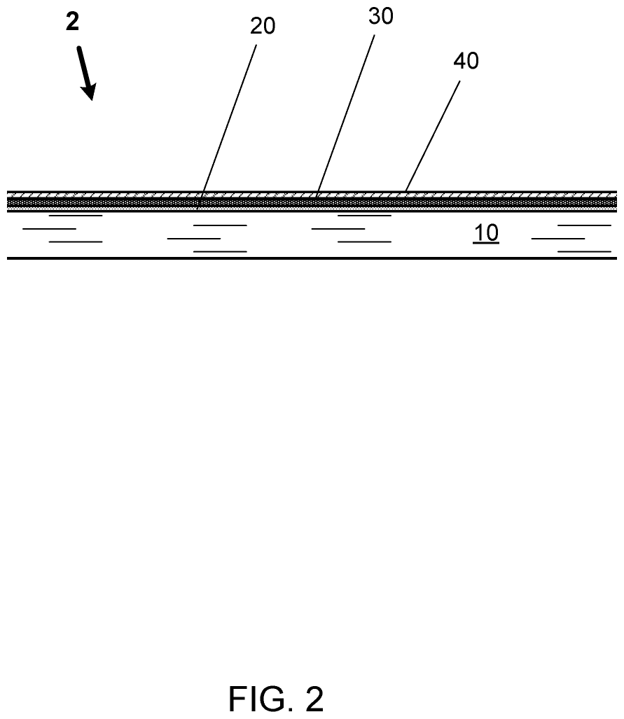

As seen in FIGS. 1 and 2, the engineered wood substrate 10 of the present invention comprises wood fibers or flakes with an engineered orientation (along with resin as a binder), which minimizes the deformation of the wood in certain orientations. The natural behavior of the wood to deform along the grains is greatly reduced by the wood construction of the engineered wood-based board or product. Whereas in the past, wood-based boards largely left the wood fiber intact throughout the manufacturing process, the engineered wood product construction used for the present invention greatly reduces the gross deformation of the product and randomizes the remaining deformation 62. Swelling in the resulting engineered-wood product is more consistent in each direction of the wood.

A resin-impregnated paper overlay is then applied (typically during the manufacturing process or during finishing) over the engineered wood substrate material. This overlay is relative rigid and water-resistant base layer that acts as a relatively non-deformable surface for the application of paint layers, powder-coatings, and/or protective coatings. A primer is applied to, or is present on, the outer or upper surface of this paper overlay. In several embodiments, the primer is pre-applied to the paper overlay before the primed overlay is placed on the top of the strand mat (i.e., bottom strands, core strands, top strands, and a fines layer, if any) pre-press. The primer must be compatible with the particular inks 30 being used, as described below. The resin impregnated paper 20 with adhesion-promoting primer 30 acts as a stable substrate for the application of film forming finishes, and the paper-primer combination provides uniform adhesion surface. The combination of the oriented substrate 10 and the paper overlay 20 thus provides an ideal surface for application of printed images or printed decorative surfaces subject to exposure outdoors. In one embodiment, the paper overlay is a medium density resin-impregnated paper overlay.

In several embodiments, the paper overlay 20 may already be impregnated with a primer layer 30 prior to being attached to the engineered wood substrate 10. In this embodiment, no additional primer layer may be needed, although in some embodiments, a second primer layer may be applied 66 as well to the integrated/impregnated primer layer (i.e., effectively providing a double primer layer).

Ink jet printer coatings for the printed layer 30 are applied in a high solids content, typically UV-cured coating direct to the primed paper. These coatings are typically applied with 4-6 colors layers ranging from CMYK (Cyan, Magenta, Yellow, Black) to CMYKOG (Cyan, Magenta, Yellow, Black, Orange, Green), and can be composed of organic or inorganic inks. In several additional embodiments, the ink used for printing is formulated for outdoor use. The ink may be a plurality of UV-resistant inks applied 68 to the surface with a variety of printing technologies (e.g., transfer, rotogravure and/or ink jet systems).

At present, organic inks provide shorter lives for UV exposures as compared to the inorganic inks. With the longer-life inorganic inks some of the brightness of colors is sacrificed. In several embodiments, viscosity should be in the range of 4 to 8 mPa, for use with printer heads using picoliters. Curing techniques include air drying and/or UV-radiation (e.g., UV-lamps), with the duration and intensity depending on the particular ink. Curing often is built into the printing system itself. Metal based inks or powder coats may be used. In such cases, heat curing may be required.

A durable, clear or transparent protective layer 40 may be applied 70 over the printed ink layer on the surface. This protective layer 40 may be in solid form (e.g., film overlay) or liquid form (e.g., liquid coating). In various embodiments, the protective layer may be applied during and/or after the printing process, such as by jetting (printing), brushing, spraying, flood coating, and the like. The protective layer protects the printed surface from UV-light damage (i.e., the protective layer protects the underlying printed ink from UV-exposure, or reduces that exposure) as well as mechanical damage. Ink as it is applied is fragile, so a UV-cured top coating composed of one of several chemistry systems (e.g., acrylic, silicone, melamine, polyurethane) enhances the life of the product. Solid protective layers may comprise different polymers, and are applied once the printed surface has fully cured. The thickness of the protective layer is correlated with the expected service life of the resulting product.

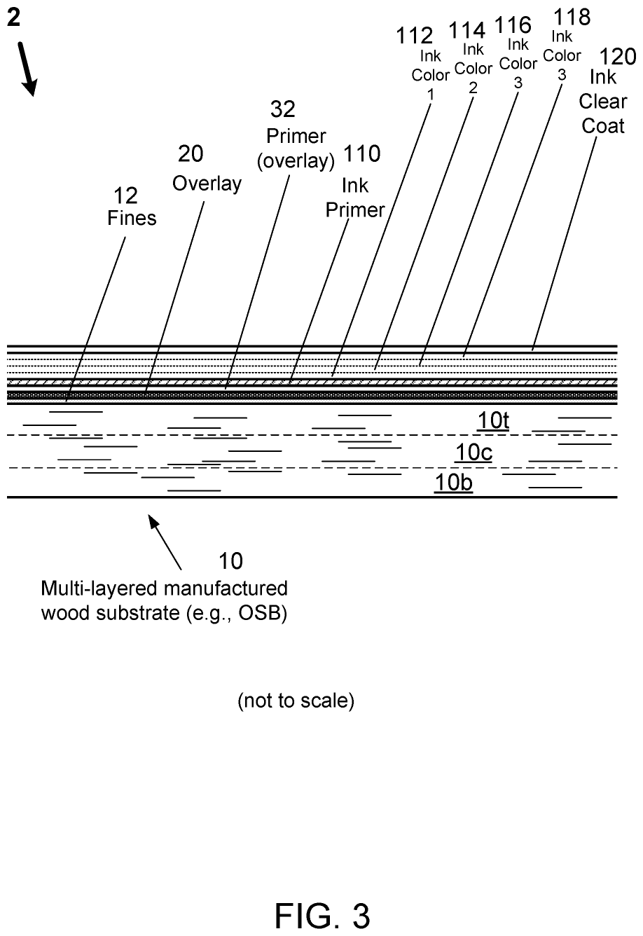

FIG. 3 shows another embodiment of the present invention detailing the sequential application of inks. The resin-impregnated paper overlay 20 is applied (typically during the manufacturing process or during finishing) over the engineered wood substrate 10 material. This overlay is relative rigid and has a water-resistant base layer that acts as a relatively non-deformable surface for the application of paint layers, powder-coatings, and/or protective coatings. A primer 32 is applied to, or is present on, the outer or upper surface of this paper overlay. In several embodiments, the primer is pre-applied to the paper overlay before the primed overlay is placed on the top of the strand mat (i.e., bottom strands 10b, core strands 10c, top strands 10t, and a fines layer 12, if any) pre-press.

In additional embodiments, an optional paint or coating layer may be applied post-press to the top surface of the primed overlay. The paint may be an acrylic paint. The coating may be a powder coating. A system and method of applying a powder coating to a manufactured wood product post-press is disclosed in U.S. patent application Ser. No. 19/050,027, filed Feb. 10, 2025, which is incorporated herein in its entirety by specific reference for all purposes.

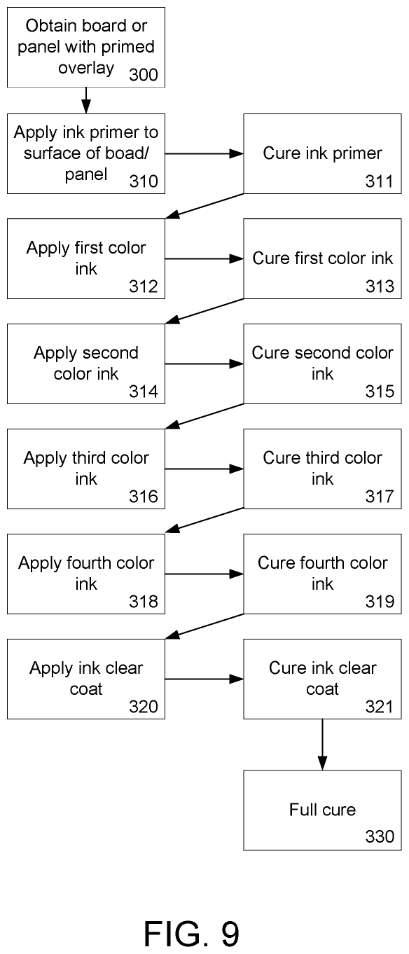

In several exemplary embodiments, the engineered-wood boards and/or panels with primed overlay, and with or without the optional paint or coating layer, subsequently go through a digital printing process described below and as seen in FIG. 9. This may occur in the same facility as the processes described above, or may occur in a separate building or facility. After being obtained or otherwise provided 300, the boards and/or panels pass through or under an industrial digital printer with multiple print heads and curing lights that automatically performs the following steps in a continuing sequence as the boards/panels pass through or underneath.
1. An ink primer 110 is applied to the upper surface of the board or panel (which typically comprises a primed overlay) (Step 310).
2. The ink primer is cured, typically by a primer-curing UV light (Step 311).
3. A first ink with a first ink color 112 is applied by a first ink print head on the surface with cured ink primer (Step 312).
4. The first ink is cured by a first UV light (Step 313).
5. A second ink with a second ink color 114 is applied by a second ink print head.
6. The second ink is cured by a second UV light (Step 315).
7. A third ink with a third ink color 116 is applied by a third ink print head.
8. The third ink is cured by a third UV light (Step 317).
9. A fourth ink with a fourth ink color 118 is applied by a fourth ink print head.
10. The fourth ink is cured by a fourth UV light (Step 319).
11. An ink clear coat 120 is applied.
12. The ink clear coat is cured by a clear coat UV light (Step 320).

After the ink clear coat 120 is cured 320, the entire board/panel is subjected to a full cure 330 with another UV light. The UV light activates binders in the inks and related components described above for curing. The inks also are UV resistant (i.e., resistant to fading from exposure to UV light over a long period of time).

The four ink colors are some combination of Cyan (C), Magenta (M), Yellow (Y) and Black (K). In one exemplary embodiment, the colors of ink are applied in the order of C, M, Y and K, although different color orders may be used. Further, different and/or additional colors may be used. The appearance of a color may be affected by the color or appearance of the underlying primed overlay substrate and/or any paint or powder coating used.

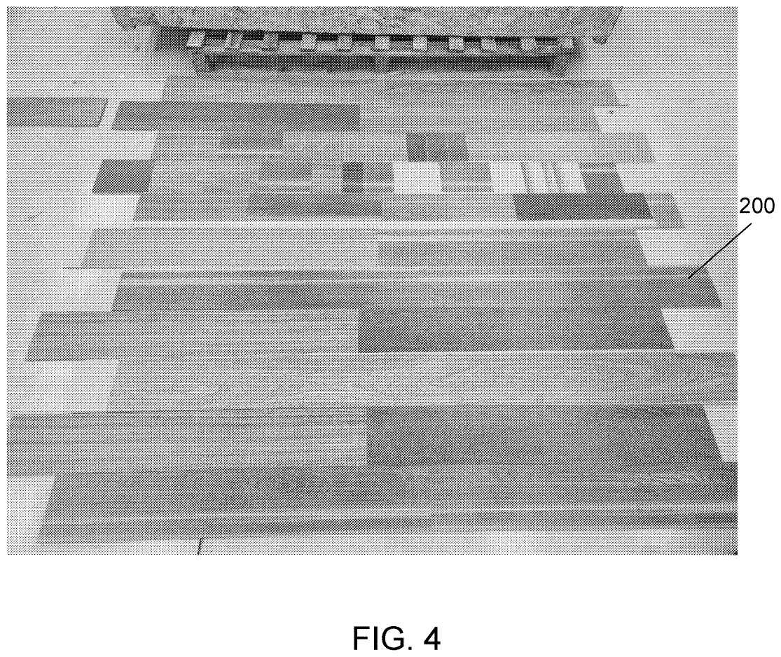

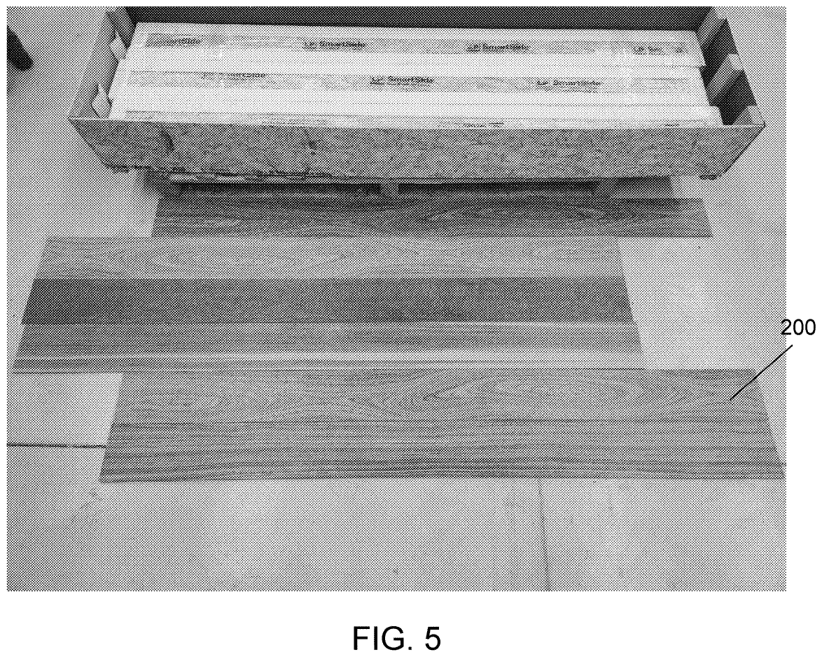

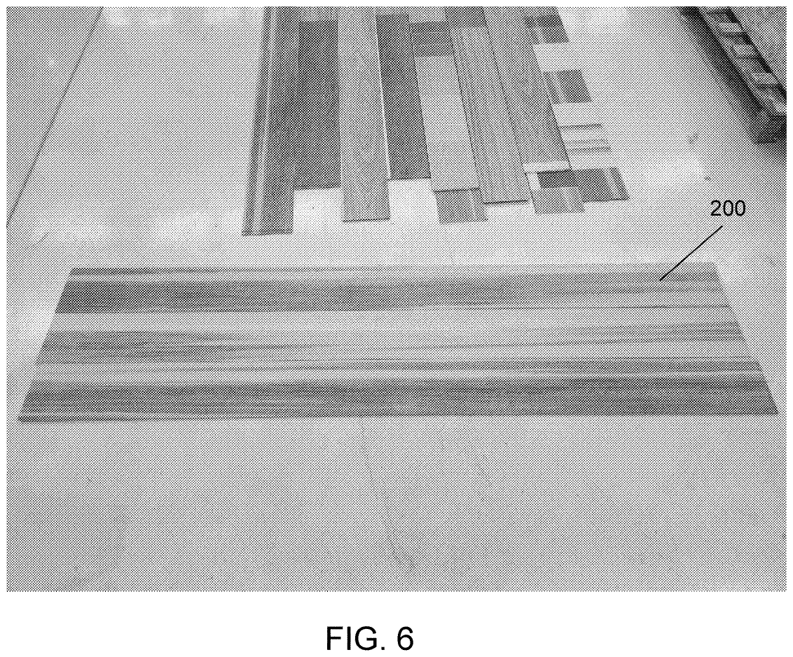

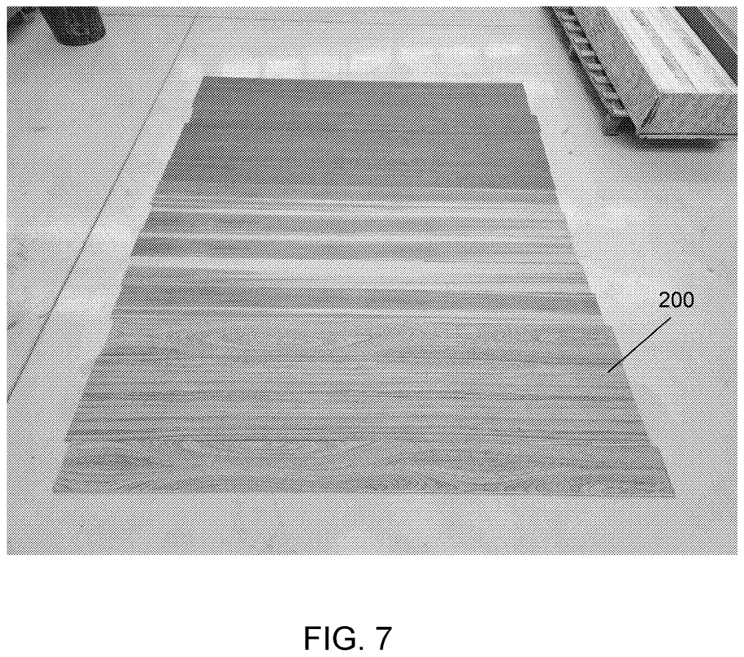

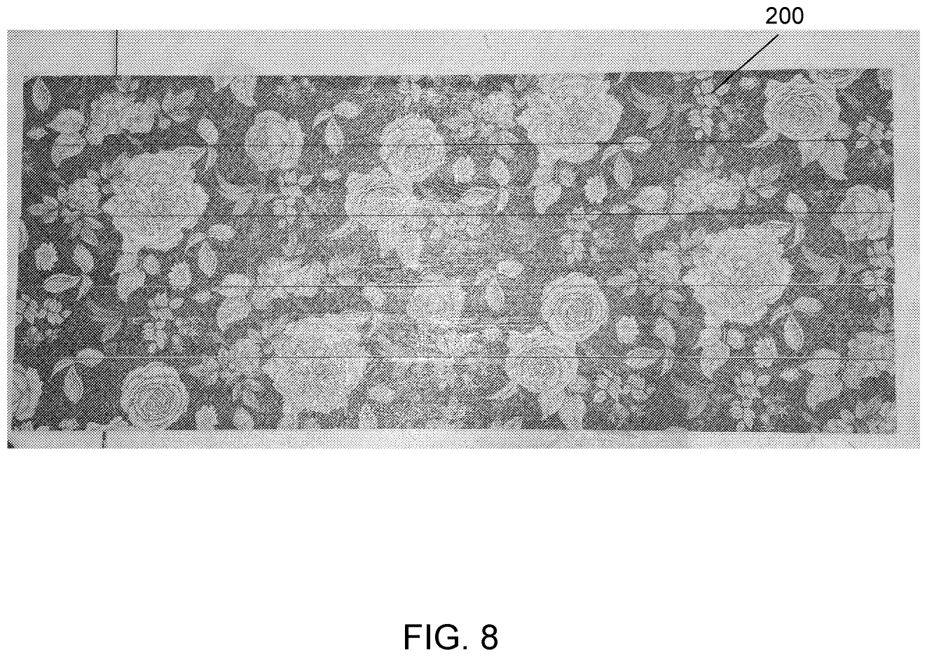

The inks are applied to the surface of the board/panel to print images or patterns 200 as programmed, including, but not limited to, wood grain patterns, masonry, brick, words, pictures, logo, and other forms of patterns or images, or combinations thereof. Examples are seen in FIGS. 4-8. In one exemplary embodiment, the boards/panels are pressed with a cedar or other wood texture imparted to the top surface by an embossment on the top press platen. The printed images may print wood grain patterns or images that correspond to or enhance the cedar texture or other texture in some way.

In additional embodiments, the system may scan the surface of the board or panel before printing to identify the presence and topography of any embossed cedar or other texture, and adjust the printing of the inks to match the embossed texture, as described above. Alternatively, the system may have a digital map of the entirety of the texture pattern (i.e., the entire texture pattern on a press platen), and then scanning portions (e.g., a portion of the ends) or all of the board or panel to first determine what portion of the texture digital map is present on the surface of the board or panel, and then make adjustments based on that determination.

In several embodiments, the present invention comprises the printing of ink to highlight or enhance the 3-dimensional cedar texture or other texture. This includes, but is not limited to, adding shading, highlights, shadows, wood knots, defects, or similar enhancements to emphasize or de-emphasize certain elements or portions of the board.

The system may scan the surface of the board or panel before printing to identify the presence and topography of any embossed cedar texture or other texture, and adjust the printing of the inks to match the embossed texture, as described above.

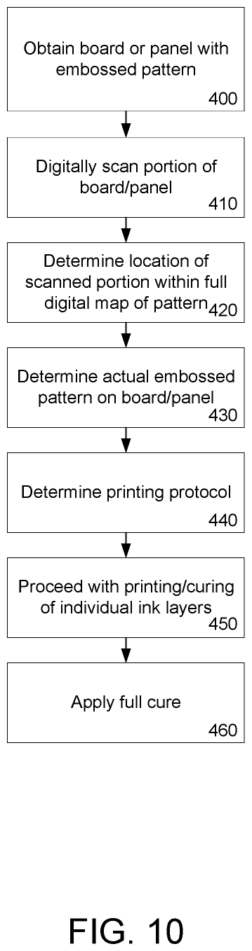

FIG. 10 diagrams a process for enhancing an embossed board or panel. First, a board or panel with an embossed cedar (or other) texture surface is obtained 400. The board or panel may only contain a part of a single texture pattern. In several embodiments, where a particular texture base pattern is a relatively small size and is repeated a number of times on the embossing plate or roller, the individual products (e.g., panels, planks and/or boards) that are cut and/or produced from a master blank produced by a primary pressing process likely only will have portions of that repeating texture pattern, and likely with those portions positioned differently on at least some of the individual boards or panel, such that not all boards or panels have the same texture pattern on their respective surfaces.

Second, the system automatically scans (such as by a 2-D or 3-D scanner) a portion of the particular board or panel to be processed to obtain a digital representation of that portion 410. The system then automatically compares the digital representation obtained to a full base texture pattern digital map (i.e., a digital representation or file of the entire single texture pattern used for the embossing) to automatically determine the location of the digital representation obtained within the full base texture pattern digital map 420. The system then uses that location, the dimensions of the board or panel (including, but not limited to, length and width), and the location of the scanned portion of the board or panel within those dimensions, to automatically determine the section of the full base texture pattern digital that corresponds to the board or panel surface, and thus determine what the full, actual embossed texture pattern across the relevant surface of the particular board or panel is 430. Of course, in some embodiments where the texture surface is unique, distinct, damaged, or a digital map for the texture pattern is not available, the system may scan all of the surface, or at least the portion of the surface to be printed upon.

The system of the present invention then automatically determines the printing protocol for enhancing, matching, or corresponding to the texture pattern on the board or panel 440. The protocol governs the application or one or more inks of specific colors or shades in particular locations or areas to create shadowing or similar effects to draw attention to certain texture features, hide or diminish features, or the like. The system then proceeds automatically with the printing and curing 450. These inks may be applied as described above with regard to one or more steps of FIG. 9. If two different inks are to be applied, then the first ink would be applied to the specific desired locations applicable to it, cured, then the second ink would be applied to another set of desired locations, which may or may not overlap with the locations for the first ink, and cured. A full cure 460 of the board/panel surface may follow the application of all of the inks.

After curing of the entire board/panel in any of the methods described above, a protective coating may be applied to prevent abrading, scratching, or other damage to the printed layers. The protective coating is a durable, clear and/or transparent coating, such as, but not limited to, an acrylic clear coat or a polyurethane clear coat. In some embodiments, a protective coating is not applied, such as when there is limited or lower exposure.

This protective layer may be in solid form (e.g., film overlay) or liquid form (e.g., liquid coating). In various embodiments, the protective layer may be applied during and/or after the printing process, such as by jetting (printing), brushing, spraying, flood coating, and the like. The protective layer protects the printed surface from UV-light damage (i.e., the protective layer protects the underlying printed ink from UV-exposure, or reduces that exposure) as well as mechanical damage. Ink as it is applied is fragile, so a UV-cured top coating composed of one of several chemistry systems (e.g., acrylic, silicone, melamine, polyurethane) enhances the life of the product. Solid protective layers may comprise different polymers, and are applied once the printed surface has fully cured. The thickness of the protective layer is correlated with the expected service life of the resulting product.

In several embodiments, the primer may be adhesion-promoting, and the overlay with primer layer thus acts as a stable substrate for the application of film forming finishes, with the paper-primer combination providing a uniform adhesion surface. The combination of the oriented substrate and the paper overlay thus provides an ideal surface for application of printed images or printed decorative surfaces subject to exposure outdoors. In one embodiment, the paper overlay is a medium density resin-impregnated paper overlay.

In several embodiments, a paper overlay may already be covered or impregnated with a primer layer prior to being attached to the engineered wood substrate. In this embodiment, no additional primer layer may be needed, although in some embodiments, a second primer layer may be applied as well to the integrated/impregnated primer layer (i.e., effectively providing a double primer layer). This second primer layer may be separate from the ink primer applied by the continuous, sequential digital printing process described above.

Ink jet printer coatings for the printed layer(s) may be applied in a high solids content, typically UV-cured coating direct to the primed paper overlay. These coatings are typically applied with 4-6 colors layers ranging from CMYK (Cyan, Magenta, Yellow, Black) to CMYKOG (Cyan, Magenta, Yellow, Black, Orange, Green), and can be composed of organic or inorganic inks. In several additional embodiments, the ink used for printing is formulated for outdoor use. The ink may be a plurality of UV-resistant inks applied to the surface with a variety of printing technologies (e.g., transfer, rotogravure and/or ink jet systems).

At present, organic inks provide shorter lives for UV exposures as compared to the inorganic inks. With the longer-life inorganic inks some of the brightness of colors is sacrificed. In several embodiments, viscosity should be in the range of 4 to 8 mPa, for use with printer heads using picoliters. Curing techniques include air drying and/or UV-radiation (e.g., UV-lamps), with the duration and intensity depending on the particular ink. Curing often is built into the printing system itself. Metal based inks or powder coats may be used. In such cases, heat curing may be required.

In several embodiments, the elasticity of the ink or ink film and/or the protective layer or film (after drying or curing) should substantially match or closely approximate the paper overlay elasticity (measured by the modulus of elasticity or Young's modulus). In one embodiment, a liquid protective layer has to remain elastic enough to bear up to 10% of surface elongation. In several embodiments, the Young's modulus/modulus of elasticity for the printed ink layer is within 10% of that for the paper overlay. In additional embodiments, the Young's modulus/modulus of elasticity for the protective layer is within 10% of that for the paper overlay.

The image or images printed can be in any form, and may include drawings, pictures, scanned images (modified and unmodified), photographs, letters, words, numbers, icons or other forms of graphic images, or combinations thereof. For example, the image may be obtained from a high-resolution scan of a board, wood or other surface, or image to be duplicated. The scan data is stored in an electronic data file, and may be modified, if desired, including, but not limited to, the addition of custom foreground or background images. The scanned image is not limited to wood, and any material (e.g., brick, stone, or the like) or image can be replicated on the substrate. The image is then printed on one or more substrates prepared as described above in a production line using a large-scale production printer. The printing duplicates the image and also can add texture and depth, based on the thickness of ink applied. The finished product may be specially packaged.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of digitally printing multiple color layers on a wood-based substrate, comprising the steps of:
providing an engineered wood board with a first surface; and
passing the engineered wood board through or underneath an industrial digital printer, wherein the industrial digital printer automatically performs the following steps in sequence:
applying an ink primer to the first surface;
curing the ink primer;
applying by a first ink print head a first ink with a first ink color to the first surface;
curing the first ink;
applying by a second ink print head a second ink with a second ink color to the first surface;
curing the second ink;
applying by a third ink print head a third ink with a third ink color to the first surface;
curing the third ink;
applying by a fourth ink print head a fourth ink with a fourth ink color to the first surface;
curing the fourth ink;
applying an ink clear coat to the first surface over all of the layers of ink;
curing the ink clear coat.

2. The method of claim 1, further comprising the step of:
after the ink clear coat has cured, full curing the entire first surface.

3. The method of claim 1, wherein the ink primer is cured by a primer UV light, the first ink is cured by a first ink UV light, the second ink is cured by a second ink UV light, the third ink is cured by a third ink UV light, and the fourth ink is cured by a fourth ink UV light.

4. The method of claim 1, where the first ink, second ink, third ink, and fourth ink are UV resistant.

5. The method of claim 1, wherein the first ink color, second ink color, third ink color, and fourth ink color are some combination of Cyan, Magenta, Yellow, and Black.

6. The method of claim 1, wherein the first ink color is Cyan, the second ink color is Magenta, the third ink color is Yellow, and the fourth ink color is Black.

7. The method of claim 1, further comprising the step of:
after the first surface has been full cured, applying a protective coating to the first surface.

8. The method of claim 1, wherein the engineered wood board comprises oriented strand board.

9. The method of claim 1, wherein the first surface comprises a paper overlay.

10. The method of claim 9, wherein the paper overlay is primed.

11. A method of enhancing an embossed surface of a wood-based substrate, comprising the steps of:
providing an engineered wood board with a surface with an embossed texture pattern, and a length and a width, wherein the embossed texture pattern on the surface is a part of a larger single texture pattern; and
passing the engineered wood board through or underneath an industrial digital printer with a processor and digital storage, wherein the industrial digital printer automatically performs the following steps in sequence:
obtaining a full digital map of the larger single texture pattern;
digitally scanning a portion of the surface to produce a digital map of the scanned portion;
comparing the digital map for the portion to the full digital map of the larger single texture pattern to determine the location of the scanned portion within the larger single texture pattern; and
determining the embossed texture pattern on the surface of the engineered wood board based on the determined location of the scanned portion, the length and width of the engineered wood board, and the corresponding portion of the full digital map of the larger single texture pattern.

12. The method of claim 11, further comprising the steps of automatically determining a printing protocol corresponding to the embossed texture pattern on the surface of the engineered wood board, and automatically printing one or more layers of ink on the surface.

13. The method of claim 12, wherein the step of automatically printing one or more layers of ink on the surface comprises the steps of automatically:
applying an ink primer to the surface;
curing the ink primer;
applying by a first ink print head a first ink with a first ink color to the surface;
curing the first ink;
applying by a second ink print head a second ink with a second ink color to the fist surface;
curing the second ink;
applying by a third ink print head a third ink with a third ink color to the surface;
curing the third ink;
applying by a fourth ink print head a fourth ink with a fourth ink color to the surface;
curing the fourth ink;
applying an ink clear coat to the surface over all of the layers of ink;
curing the ink clear coat.

14. The method of claim 11, wherein the engineered wood board comprises oriented strand board.
